(19) United States
(12) Patent Application Publication
(10) Pub. No.: US 2015/0323076 A1
(43) Pub. Date: Nov. 12, 2015

(54) SEALING RING

(71) Applicant: GAPI Technische Produkte GmbH, Rosrath (DE)

(72) Inventor: Dieter MELLER, Alfter (DE)

(21) Appl. No.: 14/640,250

(22) Filed: Mar. 6, 2015

(30) Foreign Application Priority Data
Mar. 7, 2014 (DE) 20 2014 101 042.4

(51) Int. Cl. F16J 15/16

(52) U.S. Cl. CPC F16J 15/16

(57) ABSTRACT

A sealing ring is provided for sealing a shaft or a lifting rod against a housing. The sealing ring includes a radially inner circumferential surface, a radially outer circumferential surface, and two axially aligned side surfaces. At least one of the circumferential surfaces and at least one of the side surfaces are arranged as sealing surfaces against a shaft or a lifting rod, on the one hand, and against a housing or another component arranged between them, on the other hand. The sealing ring is formed in a plurality of circular segments, respectively extending over a partial circumference of the sealing ring. The segments have at their end sections mutually corresponding connecting regions, which secure the opposite end sections of adjacent segments against mutual displacement in both axial directions of the sealing ring. A sealing arrangement is further provided using the sealing ring.

### BACKGROUND OF THE INVENTION

The invention relates to a sealing ring for sealing a shaft or a lifting rod or piston against a housing, the sealing ring comprising a radially inner circumferential surface and a radially outer circumferential surface as well as two axially aligned side surfaces, wherein at least one of the circumferential surfaces and at least one of the side surfaces are arranged as sealing surfaces against a shaft or a lifting rod or piston, on the one hand, and against a housing or another component arranged between them, on the other hand. The invention further relates to a sealing arrangement between a shaft or a lifting rod or piston against a housing, the sealing arrangement comprising a sealing ring in accordance with the invention.

Sealing rings for sealing shafts or lifting rods against a housing are known in numerous configurations, which also means in applications in solenoid valves or other valves, gears or pumps. Such sealing rings must meet numerous requirements, i.e. provide good sealing against the component to be sealed, on the one hand, and be producible true to size, on the other hand, and offer easy mounting capability. Furthermore, such sealing rings should have good temperature resistance, should offer low wear and tear, low creep tendency, low material fatigue, etc., and should optionally show dynamic response behavior under changing fluid pressure, to name but a few. Sealing rings made of high-performance plastic materials are therefore often used in order to fulfill these requirements, if possible. Such sealing rings are often produced by an injection molding method, which is especially cost-effective. Such sealing rings are known, for example, from German Utility Model DE 20 2011 00549 U1.

It is problematic in conventional sealing rings that, in the case of high sealing requirements, the sealing rings cannot always be produced with the high level of measuring precision required, especially when the sealing rings have a comparatively small diameter. The produced sealing rings are then often out of round, which impairs the sealing qualities of the sealing arrangement. Especially when the sealing arrangement is subjected to high fluid pressures, undesirably high leakage flows can occur in this case. Furthermore, the mounting of such sealing rings is often far from simple, because they need to be radially widened, e.g. when the respective sealing ring cannot be pushed in the axial direction onto the respective shaft or lifting rod, or when this would require much effort, e.g. through a preceding dismounting of the shaft or lifting rod. The bending can also negatively influence the tightness of the sealing ring arrangement, especially when high fluid pressures are exerted, or it can cause undesirable tensions in the material of the sealing ring. This especially also applies to the application of high-performance plastic materials, which are produced in a thermoplastic forming methods such as the injection-molding method.

### BRIEF SUMMARY OF THE INVENTION

The invention is based on the object of providing a generic sealing ring which comprises a synthetic material, can easily be mounted, and shows high tightness and long operational lifespan even under high fluid pressures.

This object is achieved by a sealing ring of the type described at the outset, wherein the sealing ring is formed in several parts by several segments shaped in the manner of circular segments and respectively extending over a partial circumference of the sealing ring, and wherein the segments comprise at their end sections mutually corresponding connecting regions which secure against mutual displacement the opposite end sections of adjacent segments in both axial directions of the sealing ring.

The object is further achieved by a sealing arrangement of the type described at the outset, comprising such a sealing ring and a shaft or lifting rod or piston, as well as a housing, wherein at least one of the circumferential surfaces and at least one of the side surface of the sealing ring rest in a sealing manner on a sealing surface of the shaft or lifting rod and a sealing surface of the housing.

The sealing ring in accordance with the invention is arranged in several segments, namely several circular-segment-shaped segments which extend around a partial circumference of the sealing ring, which segments—when assembled—produce the sealing ring extending over the entire circumference of the circle. The individual segments comprise mutually corresponding connecting regions on their end sections lying in the circumferential direction of the sealing ring, which connecting regions secure the opposite end sections of adjacent segments against mutual displacement in both axial directions of the sealing ring. The connecting regions on the end sections of adjacent segments thus preferably engage in the manner of a lock into each other. The axial protection against displacement of the end sections of the adjacent segments against each other thus also allows intercepting the fluid pressure in the connecting region of the segments to each other, which pressure is exerted by the pressurized fluid against which the sealing ring shall provide sealing. Furthermore, the sealing ring thus mounted on the respective component, such as the shaft of the housing, is present as a modular unit.

The multipart arrangement of the sealing ring further facilitates the mounting of the sealing ring. The sealing ring no longer need be expanded radially in order to allow sliding it in the radial direction over the respective shaft or lifting rod. Instead, the individual segments can be positioned on the outside circumference of the shaft or lifting rod for the purpose of mounting the sealing ring, and the connecting regions of the adjacent segments can be brought into engagement with each other in a manner that secures against displacement in order to mount the sealing ring on the shaft. Furthermore, the individual segments can be produced with higher dimensional precision than a fully circumferential sealing ring, e.g. also by an injection molding method by using thermoplastic materials as the sealing ring material. Non-circular arrangements of the sealing ring which can impair the tightness of the sealing ring arrangement are thus minimized or prevented. The introduction of undesirable tensions or material deformations into the widened sealing ring area is further prevented by eliminating the necessity of widening the sealing ring for the purpose of its mounting by radially moving the sealing ring towards the shaft, which material deformations could impair the tightness of the sealing ring arrangement, especially the operational lifespan of the sealing ring under alternating fluid pressures for example, especially in combination with comparatively high fluid pressures. Under these conditions, fatigue phenomena may occur more frequently in the widening area of the sealing ring in which material tensions or deformations were introduced, which may significantly reduce the operational lifespan of the sealing ring and which is prevented by the configuration of the sealing ring in accordance with the invention.

The removal of the individual sealing ring segments from the mold such as the die of an injection molding machine is facilitated by a sealing ring that is composed of several segments, as compared to an integral sealing ring, thus reducing the production costs and increasing the observable dimensional precision of the sealing ring segments.

Furthermore, the sealing ring can also be produced in accordance with the invention from high-performance synthetic materials, which materials show a comparatively high strength and/or a comparatively low elasticity. Such high-performance synthetic materials can then be increasingly optimized with respect to other properties, e.g. with respect to low wear and tear, increased media resistance against the fluid to be sealed, self-lubricating properties, increased thermal resistance or the like.

A section of a circle shall be understood as a “circular segment” within the terms of the invention, which section is bounded by two circle radii and an inner and an outer circular arc, wherein the two circular arcs are preferably those of two concentric circles.

The term “lifting rod” shall always be understood within the scope of the invention as a lifting rod or any other push rod or piston rod in the narrower sense, which substantially carries out an axial lift, but which in the wider sense preferably specifically also includes the piston.

The pressurized fluid is mostly a liquid within the scope of the invention, e.g. oil such as hydraulic oil or the like, wherein other fluids such as gases, liquefied gases or the like can be applied.

The segments comprise a first retaining projection in an especially preferable way on at least one of the connecting regions which cooperate with the respectively adjacent segment, which retaining projection engages between two axially spaced retaining regions of the opposite end section of the respective adjacent segment. The retaining regions can be arranged in form of backs or webs on the respective segment. A groove can be arranged between the two retaining regions, which groove accommodates the first retaining projection of the adjacent segment. The retaining regions or retaining backs can be arranged in such a way that they do not protrude from the body of the respective segment in the radial direction, but the retaining regions preferably extend in the radial direction up to the respective radial circumferential surface of the segment, especially the radially outer circumferential surface. The upper sides of the retaining regions and the radial circumferential surfaces of the segments are thus arranged on the same circular arc.

According to a special embodiment, the radial outer surfaces of the retaining regions and the first retaining projection which is arranged between the retaining regions are part of the sealing surfaces of the sealing ring against the component to be sealed such as a housing, wherein the sealing surface in sealing arrangement of the sealing ring can then especially represent a cylinder surface with a circular cross-section. The sealing ring can optionally be arranged—as is common practice—in a bush which can be part of the housing.

The first retaining projection of the first segment engages in an especially preferred manner in the two axial directions without play between the two axially spaced retaining regions of the adjacent segment.

In an especially preferred manner, the end sections of the segments of the sealing ring are arranged in such a way that they comprise at least one first retaining projection protruding in the circumferential direction of the segment, which retaining projection preferably engages above and/or beneath an end section of the adjacent segment. This enables secure fixing of the segments to the respective component such as the shaft, lifting rod or housing, and further increases the tightness of the connecting region of the individual segments. This further ensures in particular that the sealing ring can be pre-mounted on the respective component such as the shaft or the lifting rod before the shaft or lifting rod is mounted on the housing.

The individual segments of the sealing ring are thus preferably captively fixed to each other, especially preferably by an interlocking and/or frictionally engaged connection to each other. This can especially preferably be achieved in such a way that the individual segments, including the retaining projections which extend therefrom in the circumferential direction, extend by more than 180° in the circumferential direction of the sealing ring and overlap each other with partial areas. The individual segments can be arranged in such a way that they can only be removed from the shaft or the lifting rod by widening in the radial direction, wherein it is only necessary to widen one region of the segment for the purpose of dismounting from the other segment or the shaft or the lifting rod, wherein the region has a lower or considerably lower material thickness than the body of the segment. In particular, the segment can thus be arranged in such a way that the widening only occurs in one region of the segment, wherein the sealing surface on the body of the respective segment need not be deformed. Furthermore, a portion of the sealing surface in the connecting region of the segment need not be deformed, so that the axially spaced retaining regions of the sealing ring for example, which laterally enclose the first retaining projection, need not be deformed during the mounting of the sealing ring. Problems with tightness are thus minimized.

The term “circumferential direction” within the scope of the invention shall relate generally to the sealing ring or with respect to the segment relating to its arrangement on the sealing ring, unless stated otherwise in detail from the context.

The term “axial direction” within the scope of the invention relates generally to the central axis of the sealing ring which coincides with the central axis of the shaft or the lifting rod accordingly when the sealing ring is mounted.

The “body” of the respective segment relates to the region of the segment which is provided with a radially inner or radially outer sealing surface, which can be placed in a sealing fashion on the shaft or lifting rod or the housing. This is usually simultaneously the region of the segment with the greatest material thickness in the radial direction. The body thus preferably provides the sealing surface region with the greatest axial extension. Regions of the end sections of adjacent sealing ring segments can optionally rest with a specific amount of pretension on each other when the sealing ring is mounted. The connection of the segments by forming the sealing ring is thus improved, which is especially preferred in specific applications. Retaining projections (especially the first retaining projections and/or optionally additional projections such as the second retaining projections) can be arranged at least in sections with slight deviation from the shape of a circular arc relating to the dismounted state of a separate segment, i.e. it can be arranged in sections with a narrower radius. In the mounted state, this region will then preferably adjust to the circular arc shape of the sealing ring.

The mounted sealing ring can rest with a specific amount of radial pretension or in a loose fashion on one of the two components of shaft, lifting rod or housing to be sealed. In the case of sealing in relation to components moved rotationally with respect to each other, the sealing ring preferably rests with a specific amount of radial pretension on one of the components such as the housing. In the case of translatory motions of the components to be sealed against each other, the sealing ring preferably does not rest with radial pretension on the two components.

The circumferential extensions of the sealing surfaces of the segments, which are arranged on the radially inner side or the radially outer side on the sealing ring, preferably add up to 360°. As a result, the surface of the respective component to be sealed such as the shaft, the lifting rod or the housing is completely sealed by the segment in total, thus achieving a high tightness of the sealing ring arrangement. In special applications, the bodies of the segments, and thus also the radially inner or radially outer sealing surface thereof, can optionally be slightly spaced from each other in the circumferential direction, e.g. in order to enable better compensation of temperature fluctuations and to enable the use of the sealing ring in a greater temperature range.

The at least one retaining projection of the respective segment (in particular the first retaining projection) preferably extends ≧5° or ≧10°, preferably ≧20° or ≧30°, more preferably ≧40° or ≧60° beyond the sealing ring circumference, relating to the region protruding from the body of the segment in the circumferential direction. The aforementioned retaining projection can extend ≦150° or ≦125°, or preferably ≦110° or ≦90°, beyond the sealing ring circumference, relating to its region protruding from the segment body in the circumferential direction. This enables simple mounting of the segments on the one hand, and ensures a good retaining force of the segments on the shaft with mounted sealing ring on the other hand, because this provides sufficient to very good overlapping of the segments in the circumferential direction. Furthermore, great extension of the retaining projections in the circumferential direction is especially advantageous with respect to widening the respective retaining projection without thus deforming the body of the segment. Furthermore, great extension of the retaining projections in the circumferential direction is especially advantageous with respect to the arrangement of a fluid channel, as described below.

The retaining regions of the respective segment are especially preferably also arranged as projections (second projections), between which the first retaining projection of the adjacent segment is accommodated in a manner that is secured against axial displacement, which second projections protrude from the face end of the respective end section of the segment in the circumferential direction. The second retaining projections can protrude from the respective face end by ≧5° or ≧10°, e.g. ≧15°, preferably ≦45° or ≦30° or ≦20°, respectively relating to the sealing ring circumference. This facilitates joining of the segments, especially when the end section of the adjacent segment is provided with a longer retaining projection.

First and second retaining projections are provided in an especially preferred manner on the two end regions of the respective segment, which retaining projections protrude from the segment body in the circumferential direction and which can be brought to overlapping with regions of the end sections of the respectively adjacent segments. The retaining projections on the two opposite end sections of the respective segment can protrude to a differently far extent in the circumferential direction from the respective body. If two or more retaining projections in the axial direction of the sealing ring are arranged on an end section of a segment (second retaining projections), they can protrude at least to a substantially equal extent or optionally different extent from the respective segment in the circumferential direction of the sealing ring.

The retaining regions, especially when formed as retaining backs or second retaining projections, can be arranged on the radial side of the segment which forms the sealing surface of the segment in relation to the component to be sealed such as the shaft, lifting rod or housing. The retaining region and retaining projection can optionally also be arranged on the circumferential side of the sealing ring which is opposite of the sealing surface.

The retaining projections and/or retaining regions preferably do not protrude in the radial direction beyond the circumferential surface of the respective segment, especially in the mounted state of the sealing ring, and more preferably the retaining projections and/or retaining regions are also arranged as circular segments which are integrally attached to the circular-segment-shaped segments. This can respectively relate to the first and/or second retaining projections. Retaining projections are preferably provided on the two end regions of the respective sealing ring segment which protrude from the segment body in the circumferential direction, and under certain circumstances it is sufficient if a respective (first) retaining projection is arranged on only one of the two end regions of the segment. Respective recesses or openings for accommodating the respective retaining projection are preferably respectively provided on the corresponding end region of the adjacent segment which is to be connected to the prior mentioned segment. At least one retaining projection can be arranged on at least one or precisely one of the end sections, which retaining projection is adjacent to the side surface of the segment. The two retaining regions or the two retaining projections of the respective segment are preferably directly laterally adjacent to the two side surfaces of the segment.

It is generally understood within the scope of the invention that the entire arrangement of the side surfaces of the segments forms the two side surfaces of the sealing ring, respectively with respect to the one or the other side of the sealing ring.

The first and the second retaining projections of the segments can protrude to a differently far extent in the circumferential direction beyond the segment body. The retaining projections are preferably arranged in the axial direction of the respective segment (or the sealing ring) on the end region of the segment on which retaining projections of lower length are arranged, i.e. with lower circumferential extension protruding from the segment, in order to enable accommodating a (first) retaining projection of the end section of the adjacent segment between them. The holding projection of the adjacent segment, which is thus arranged between two axially spaced retaining projections of the prior mentioned segment, can have a greater length (or a greater projection beyond the respective segment in the circumferential direction) than the other retaining projections.

The first retaining projection of a segment respectively lies laterally on the retaining regions of the adjacent segment in order to produce an arrangement which is as fluid-tight as possible. In particular, the first and second retaining projections of the adjacent segments, which are arranged in succession in the axial direction of the sealing ring, preferably rest laterally on each other. The axial contact surfaces of the retaining projections or retaining regions of adjacent segments are preferably arranged in a flat manner. All side surfaces of the individual sealing ring sections, especially the segment bodies and the respective retaining projections thereof, can be arranged in form of circular segments.

The radially inner and radially outer circumferential surfaces of the segments are respectively preferably arranged as cylinder sections, relating to the circumference of a cylinder. The side surfaces of the retaining projections and/or retaining regions can thus be arranged perpendicularly to the axial direction of the sealing ring. The side surfaces of the retaining projections and/or retaining regions can optionally also be arranged in an inclined manner relative to the axial direction of the sealing ring, i.e. assume an angle of ≠90°. The side surfaces of retaining projections or holding regions of adjacent segments sitting close to each other are thus preferably arranged with the same angle but with inclination in the opposite direction to the axial direction of the sealing ring, so that flat contact regions extend, preferably fully flat contact regions. The retaining projections and retaining regions of the end regions can thus optionally engage into each other in a dovetail-like fashion or in any other manner. Side surfaces of the retaining projections and retaining regions which are arranged perpendicularly to the axial direction are especially preferred, because this allows radial widening or displacement of the segments or segment regions with respect to each other, e.g. in the case of fluctuating fluid pressure, especially in combination with the arrangement of fluid channels in the boundary surfaces of the segments or holding projections arranged on the radially inner side or radially outer side, as described below.

The sum total of the length of the retaining projections protruding in the circumferential direction at the two end sections of the respective segment is especially preferably ≧45-60°, preferably ≧70-80°, more preferably ≦120-135°, more preferably ≦100-110°, e.g. approx. 90°.

The respective segments of the sealing ring are preferably arranged in an integral manner, e.g. as injection molded parts.

A pocket-shaped recess is especially preferably provided upstream of the free end of at least one of the retaining projections of the sealing ring segment, especially the first retaining projection of the segment, or in particular only the free end of the first retaining projection of the respective segment, which recess is preferably embedded in the respective circumferential surface of the adjacent segment, wherein the recess is connected in a fluid-guiding manner to the surrounding environment of the sealing ring. The recess is preferably arranged in an open fashion towards the radial circumferential surface of the respective segment, wherein it is preferably the radial circumferential surface to which the aforementioned retaining projection of the adjacent segment is arranged adjacently. In particular, the pocket-shaped recess can be arranged in the radial sealing surface of the sealing ring. The pocket-shaped recess can be hydraulically effective in the sealing, especially in case of applications with fluctuating fluid pressures. The pocket-shaped recess can also act in the manner of a lubricating pocket for example in order to reduce friction of the sealing ring with respect to the component such as the housing to be sealed. Hydraulic triggering of the sealing ring under alternating fluid pressures can optionally be provided by the penetration of fluid into the pocket-shaped recess against which the sealing ring seals.

The pocket-shaped recess is preferably arranged adjacent to the retaining projection, which protrudes with the greatest circumferential extension from the respective segment body, so that this optionally also enables effective hydraulic triggering of the sealing ring, which may also occur as a result of increased elasticity of the elongated retaining projection against other partial regions of the sealing ring. The pocket-shaped recess is preferably arranged adjacent to a retaining projection which lies in the main central plane of the sealing ring, thus optionally avoiding undesirable tilting or torsional forces on the sealing ring or segments when the fluid pressure is applied.

A fluid channel is arranged in an especially preferred manner between the retaining projection of a first segment (especially the first retaining projection of the segment) and the region of the adjacent segment which is overlapped by the retaining projection (engaging above or beneath the same), which fluid channel is connected in a fluid-guiding manner to the ambient environment of the sealing ring and thus against the fluid which is sealed by the sealing ring. The fluid channel can be arranged on the retaining projection or the section of the adjacent segment which is opposite thereto and overlapped thereby, optionally also in both regions. The fluid channel preferably opens into a circumferential surface of the sealing ring. The fluid channel opens in an especially preferred manner into the pocket-shaped recess which is arranged on the face end of the retaining projection. The sealing ring can be triggered hydraulically by the pressurized fluid through the fluid channel, optionally under radial pressing of the first retaining projection against its contact or sealing surface of the corresponding component such as the housing for example. Such an embodiment of the sealing ring is especially advantageous in apparatuses with pressure fluctuations of the fluid.

Such a fluid channel can optionally generally be provided between sections of adjacent segments which overlap each other in the radial direction, wherein the aforementioned embodiment is especially advantageous. The fluid channel can extend ≧5-10° or ≧15-20°, preferably ≧30-40° or ≧50-60°, over the sealing ring circumference, wherein in this case the channel is surrounded over the aforementioned extension on both sides by the mutually radially overlapping regions of the adjacent segments, especially by limiting the fluid channel on one side by the (first) retaining projection of the respective segment. In particular, the fluid channel can extend over virtually the entire circumferential extension of the (first) retaining projection, which is pressurized in the radial direction by the fluid guided in the channel. The channel can optionally be spaced in the circumferential direction from the face ends of the two sealing ring segments which come into contact with each other in order to increase the tightness of the sealing ring on the mutually opposite face ends of the adjacent sections.

The sealing ring consists in an especially preferred manner of only two segments, and optionally of several segments which is less preferable.

The segments of the sealing ring are respectively identical in construction with respect to each other in an especially preferred way, even when the sealing ring comprises more than two segments.

The sealing ring can comprise thermoplastic synthetic materials, especially thermoplastic high-performance synthetic materials such as PEK, PEEK, PTFE, PSU and polyimide or the like, without being limited to the materials.

The sealing ring can especially be produced with an only small total diameter, e.g. a diameter in the range of ≦40 to 50 mm or ≦30 mm, without being limited thereto. The material thickness of the sealing ring can be ≦8 to 10 mm or ≦4 to 6 mm, and optionally also ≦3 mm.

The sealing ring is generally described with its preferred application, comprising a radial sealing surface against the housing (or the bushing) and a lateral sealing surface against the shaft or lifting rod, wherein a specific (low) play can be provided in relation to the shaft or lifting rod. It is understood that the sealing ring could also be configured in an “inverse” manner, comprising a radial sealing surface against the shaft or lifting rod and a specific (low) play in relation to the housing, with a respective reversal of the position of the functional regions (e.g. with radially inner long retaining projection in this case). This especially also applies to the embodiment.

With respect to a sealing arrangement comprising the sealing ring in accordance with the invention, the sealing ring can especially be arranged in a circumferential groove of the shaft or lifting rod. It is advantageous in this case that the sealing ring only requires a very low thickness. One of the groove flanks can be arranged as a sealing surface. If the sealing ring is arranged in a housing groove for example, one of the flanks of the groove can be arranged as a sealing surface. It is understood that it is also possible that both of the groove flanks can be arranged as sealing surfaces.

Sealing rings in accordance with the invention have proven to be especially advantageous in sealing ring arrangements in valves, especially solenoid valves, gears or pumps.

The sealing ring can especially be pressurized in application in the respective apparatus with a fluid pressure of ≧15-20 bars or ≧25-30 bars, e.g. also ≧40 bars or ≧50 bars.

An O-ring can be arranged in the groove of the respective component accommodating the sealing ring, especially on the low-pressure side of the sealing ring. The O-ring can rest on a side surface of the sealing ring, without pressurization by a fluid in the axial direction or under such pressurization. This applies in particular in the case of a sealing arrangement of the sealing ring on components which are moved in a translatory fashion such as a lifting rod.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings FIGS. 1 to 5 show an example of an embodiment of a sealing ring in accordance with the invention, so that reference is made in general thereto. This embodiment illustrates a sealing ring consisting of two segments in different mounting positions of the segments in a side view (FIGS. 1 to 3), in a perspective view (FIG. 4), and in a cross-sectional view mounted in a housing of a sealing arrangement (FIG. 5). In particular:

FIG. 1 is an exploded side view showing the two separate segments of which the functional sealing ring of the embodiment is composed;

FIG. 2 is a side view of a partially mounted arrangement of the two segments from FIG. 1, wherein the drawing only shows the segments placed on top of each other, but without widening of the retaining projections;

FIG. 3 is a side view showing the sealing ring of FIG. 1 as it would appear in a state mounted on a shaft or on a lifting rod, such as in an arrangement in a housing according to FIG. 5;

FIG. 4 is a perspective view of the mounted sealing ring of FIG. 3; and

FIG. 5 is a schematic, cross-sectional view of a housing showing examples of two sealing arrangements with sealing rings in accordance with embodiments of the invention.

### DETAILED DESCRIPTION OF THE INVENTION

The sealing ring 1 in accordance with the invention can be used for sealing a housing 150 against a shaft or a lifting rod (each designated in the drawings by ref. no. 100), with shaft axis 101 (which is identical to the sealing ring axis). The sealing ring 1 has a radially inner circumferential surface 2 and a radially outer circumferential surface 3, as well as two axially aligned side surfaces 4, 5, wherein at least one of the circumferential surfaces (surface 3 for example) and at least one of the side surfaces (surface 4 in this case) are arranged as a sealing surface against the housing 150 on the one hand and the shaft or lifting rod 100 on the other hand. The illustration on the left in FIG. 5 is mostly used in the arrangement of a shaft (rotational movement). The illustration shown on the right side in FIG. 5 is mostly used in the arrangement of a lifting rod (axial movement) with the high-pressure side being on the right side, by way of example, (the O-ring on the low-pressure side). In FIG. 5, the side surface 4 of the sealing ring 1 which rests on the O-ring 130 finally also provides sealing against the component, which in this case is that of the lifting rod 100. The sealing ring is simultaneously used to support the O-ring in its target position. It is understood that the invention can also be applied generally when the radially inner circumferential surface of the sealing ring is the sealing surface, wherein the embodiment must be interpreted with respective reverse configuration.

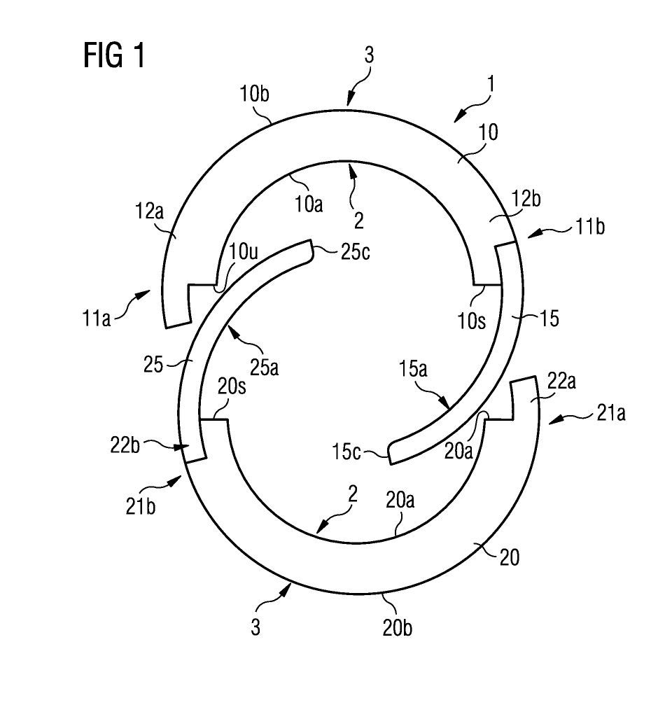

The sealing ring 1 is arranged in this case in several parts with several segments 10, 20, which respectively extend over its partial circumference and are arranged in the manner of circular segments, which sealing ring is composed in this case of precisely two such segments. The circular segments respectively comprise at their end sections 11a, 11b and 21a, 21b (FIG. 1) mutually corresponding connecting regions 12a, 12b and 22a, 22b, which secure the mutually opposite end sections of the other segment against mutual displacement in both axial directions of the sealing ring 1.

The two segments 10, 20 comprise radially inner and radially outer circumferential surfaces 10a, 10b, 20a, 20b according to the sealing ring, which circumferential surfaces produce the circumferential surface of the sealing ring when assembled. The radially outer circumferential surface 3 of the sealing ring is the sealing surface against the housing 150 in this case (FIG. 5).

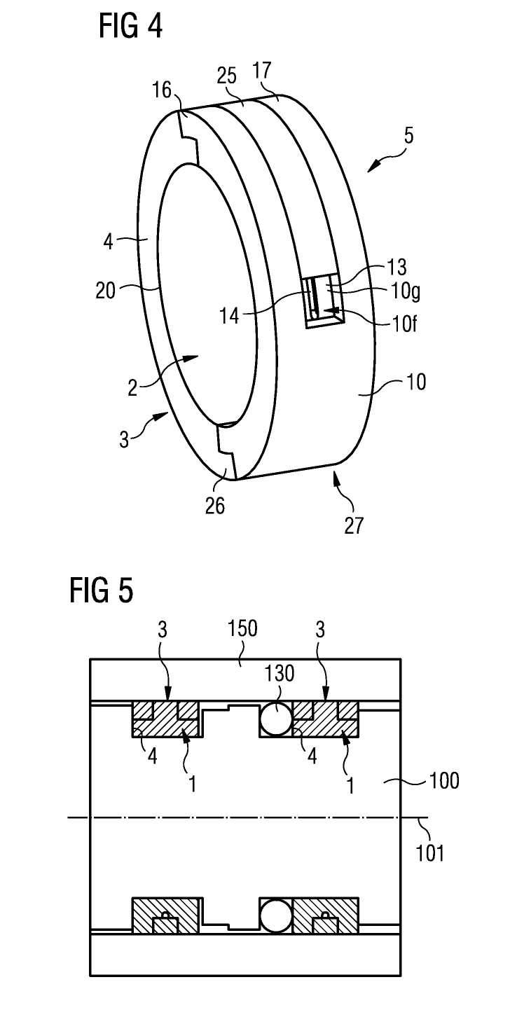

A respective first retaining projection 15 and 25 is provided on the two mutually corresponding connecting regions 12a, 12b, 22a, 22b of opposite end sections of the two segments 10, 20, which retaining projection engages between two axially spaced retaining regions 16, 17; 26, 27 of the opposite end section of the adjacent segment, as shown in FIG. 4. The retaining regions 16, 17; 26, 27 are arranged here as backs or webs, which form a groove between themselves into which the first retaining projection 25, 15 of the respectively adjacent segment engages. The grooves are open in this case in a radial direction, which is the radially outside direction in this case (see groove 10f on segment 10, which is respectively identical on the other segment).

The engagement of the first retaining projection 15, 25 of the first segment 10, 20 occurs in both axial directions without play between the two axially spaced retaining regions of the adjacent segment (e.g. retaining projection 15 with respect to the retaining regions 26, 27 of the second segment 20; retaining projection 25 with respect to the retaining regions 16, 17 of the first segment).

The retaining projection of the first segment engages beyond the adjacent segment in the radial direction when the sealing ring is assembled. In accordance with the embodiment, the retaining projection 15 of the segment 10 engages beyond the second segment 20. The retaining projection 25 of the second segment 20 engages beyond the other segment 10. The radial boundary side of the respective retaining projection, which in this case is the radially inner side 15a, 25a (“bottom sides” of the retaining projections 15, 20), can rest on the facing side of the other segment. In accordance with FIG. 4, the bottom side 25a of the projection 25 rests on the groove base 10g of the groove 10f, and correspondingly for the other segment. In the case of suitable configuration of the retaining projections (or the corresponding contact surfaces of the other segment), which is provided here by radially inward bending of the long retaining projection 15, 25 with respect to the dismounted and non-loaded state thereof, the respective retaining projection 15, 25 can also rest with a certain radially directed pretension on the other segment, which promotes cohesion of the sealing ring.

The retaining regions 16, 17; 26, 27 for the first retaining projection of the adjacent segment are additionally arranged in this case as retaining projections, which protrude from the face ends of the end regions in the circumferential direction. The protruding sections preferably converge in this case with constant cross-section into the back-shaped or web-shaped sections on the segment bodies (see FIG. 4).

The retaining projections 15, 25 and the retaining regions 16, 17; 26, 27 of the other segment which cooperate with the retaining projections can protrude beyond the face end of the respective segment over a circumferential angular extension of ≧5°. The retaining projections 15, 25 protrude by approximately 75° from the face ends 10s, 20s of the bodies of the segments 10, 20. The retaining regions 16, 17; 26, 27 protrude by approximately 15° from the face ends 10u, 20u of the bodies of the segments 10, 20. The retaining projections 15, 25 thus protrude considerably farther in the circumferential direction than the regions 16, 17; 26, 27.

The two segment bodies or radial sealing surfaces of both segments respectively extend by 180° in the circumferential direction in order to respectively produce 360° with respect to the sealing ring.

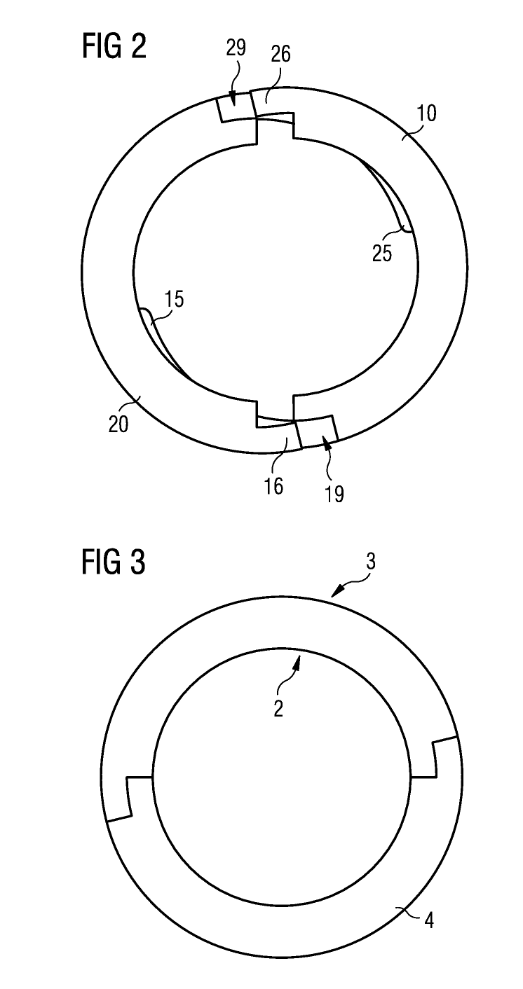

Sealing ring mounting can occur by radial outwardly bending the first (long) retaining projections 15, 25 and sliding the two segments together for forming a full circle under formation of the sealing ring, but without deformation of the segment bodies or sealing surfaces 10a, 20a of the segment bodies and without deformation of the sealing surfaces of the retaining regions, including the regions thereof protruding in the circumferential direction. The (longer or middle) retaining projections 15, 25 are introduced into the corresponding grooves of the respective other segment. The (shorter or lateral) regions 16, 17; 26, 27 are introduced into the corresponding, laterally open pockets 19, 29 of the adjacent segment (see FIG. 2). In the mounted state of the sealing ring, all face ends of the segment bodies and the retaining projections come into contact in a flat manner, and preferably in a fully flat manner, so that the sealing ring is assembled with the fewest possible gaps (apart from the pocket-shaped recesses that are described below). Furthermore, the side surfaces of the first retaining projections come into flat lateral contact (preferably in a sealing manner) with the side surfaces of the retaining regions, preferably including the protruding sections thereof.

When the sealing ring is assembled, a pocket-shaped recess 13 is provided upstream in the circumferential direction of the sealing ring on the free face end 25c of the retaining projection of the first segment (shown here in FIG. 4 as segment 20), which recess is adjacent to the face end 25c of the retaining projection of the first segment 20. The recess 13 is provided with an open configuration in the radial direction of the sealing ring with respect to the circumferential surface of the segment, which accommodates the retaining projection (the radially outer surface in this case), or the recess is in connection in a fluid-guiding manner with the ambient environment of the sealing ring in another way. This provides hydraulic triggering capability of the sealing ring. The pocket-shaped recess is arranged in this case in the sealing surface of the sealing ring.

A fluid channel 14 is arranged between the boundary surface of the retaining projection facing the adjacent segment and the boundary surface of the adjacent segment facing the retaining projection of the first segment, which fluid channel is connected in a fluid-guiding manner to the ambient environment of the sealing ring. This amplifies the hydraulic triggering ability of the sealing ring, wherein the first retaining projections can be pressed radially against the housing by the fluid pressure of the first retaining projections, optionally by increasing the sealing effect. The fluid channel opens in this case into a circumferential surface of the sealing ring, namely via the recess 13. A lubricating effect by the fluid can optionally be achieved in this way.

The pocket-shaped recess extends in this case over approximately 5 to 10° of the circumferential extension of the sealing ring. The fluid channel extends over approximately 60° of the circumferential extension of the sealing ring, namely substantially over the length of the retaining projections 15, 25.

The pocket-shaped recess and/or fluid channel is respectively arranged in the other segment (not shown). The segments of the sealing ring are arranged in an identical manner with respect to each other.

The sealing ring segments comprise in this case a thermoplastic synthetic material. The segments are produced by way of an injection molding method.

A sealing arrangement having a sealing ring and a shaft or lifting rod as well as a housing is shown in FIG. 5, wherein the side surface of the sealing ring rests in a sealing manner on a sealing surface of the shaft or lifting rod (groove flank of the shaft or rod groove) and a sealing surface of the housing (radially inner surface thereof). The sealing ring can rest in a play-free manner or with pretension on the circumference of the shaft or lifting rod (or the groove base).

The O-ring 130 arranged on the low-pressure side of the sealing ring has the diameter (inner and outer diameter) of the sealing ring, so that the groove base is arranged in a flat manner in the cross-section over the region of the sealing ring and the O-ring, or the groove can have a constant depth, which can be applied generally within the scope of the invention. The O-ring also has a sealing effect against the housing and the component that is moved with respect to the housing such as the lifting rod or optionally the shaft.

The retaining projection 15, 25 respectively has (at least one) radial thickness which is greater than radial play between the sealing ring and shaft or housing at the height of the respective retaining projection. The middle retaining projection is thus not able to unthread from the groove of the sealing ring which is formed by the adjacent retaining regions.

The sealing arrangement can be operated with a pressure of ≧35 bars, e.g. approx. 50 bars. The sealing arrangement can be, for example, a valve, especially a solenoid valve, a gear or a pump.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-30. (canceled)

31. A sealing ring for sealing a shaft, lifting rod or piston against a housing, the sealing ring comprising a radially inner circumferential surface, a radially outer circumferential surface, and two axially aligned side surfaces, at least one of the circumferential surfaces and at least one of the side surfaces being arranged for resting against sealing surfaces of the shaft, the lifting rod or the piston and against a sealing surface of the housing or another component arranged between them, the sealing ring being formed in a plurality of parts shaped as circular segments and respectively extending over a partial circumference of the sealing ring, wherein the circular segments comprise at their end sections mutually corresponding connecting regions which secure opposite end sections of adjacent segments against mutual displacement in both axial directions of the sealing ring.

32. The sealing ring according to claim 31, wherein the circular segments respectively comprise a first retaining projection on at least one of the connecting regions which cooperates with the adjacent segment, and wherein the first retaining projection engages between two mutually axially spaced retaining regions of the opposite end section of the adjacent segment.

33. The sealing ring according to claim 32, wherein the engagement of the first retaining projection occurs in both axial directions without play between the two mutually axially spaced retaining regions of the adjacent segment.

34. The sealing ring according to claim 32, wherein the first retaining projection engages beyond or beneath the adjacent segment in a radial direction when the circular segments of the sealing ring are assembled.

35. The sealing ring according to claim 32, wherein the first retaining projection rests facing radially inward or radially outward on the opposite end section of the adjacent segment.

36. The sealing ring according to claim 32, wherein the first retaining projection rests with radial pretension on the opposite end section of the adjacent segment.

37. The sealing ring according to claim 32, wherein the spaced retaining regions of the adjacent segment secure the first retaining projection against axial displacement, the spaced retaining regions being arranged as second retaining projections which protrude from an face end of the respective end section of the circular segment in a circumferential direction.

38. The sealing ring according to claim 37, wherein the circular segment comprises receivers for the second retaining projections of the adjacent segment.

39. The sealing ring according to claim 38, wherein the receivers for the second retaining projections are arranged on the respective segment in the axial direction directly adjacent to the first retaining projection and at its height, such that when the sealing ring is mounted for use the first retaining projection is arranged adjacent to the second retaining projections of the adjacent segment.

40. The sealing ring according to claim 32, wherein the first retaining projection protrudes by a circumferential angular extension of ≧5° beyond an face end of the circular segment facing the adjacent segment.

41. The sealing ring according to claim 32, wherein the sealing ring in assembled condition further comprises a pocket-shaped recess upstream in a circumferential direction of the sealing ring on a free face end of the first retaining projection, the recess having an open configuration in a radial direction of the sealing ring with respect to the circumferential surfaces of the circular segment which accommodates the first retaining projection, the recess being in connection with an ambient environment of the sealing ring in a fluid-guiding manner.

42. The sealing ring according to claim 41, wherein a fluid channel is arranged between a boundary surface of the first retaining projection facing the adjacent segment and a boundary surface of the adjacent segment facing the first retaining projection, the fluid channel being connected in a fluid-guiding manner to the ambient environment of the sealing ring.

43. The sealing ring according to claim 42, wherein the fluid channel opens into at least one of the circumferential surfaces of the sealing ring.

44. The sealing ring according to claim 42, wherein the fluid channel opens into the pocket-shaped recess.

45. The sealing ring according to claim 42, wherein the pocket-shaped recess extends over more than 3° of a circumferential angular extension of the sealing ring.

46. The sealing ring according to claim 31, wherein the sealing ring consists of precisely two segments.

47. The sealing ring according to claim 31, wherein the segments of the sealing ring are respectively identical to each other in construction.

48. The sealing ring according to claim 31, wherein the segments thereof comprise a synthetic thermoplastic material processible by injection molding.

49. A sealing arrangement comprising a sealing ring according to claim 31, a shaft, lifting rod or piston, and a housing, wherein at least one of the circumferential surfaces and at least one of the side surface of the sealing ring rest in a sealing manner on the sealing surface of the shaft, lifting rod or piston and the sealing surface of the housing.

50. The sealing arrangement according to claim 49, wherein the sealing ring rests without play or with radial pretension on the shaft, lifting rod or piston.

51. The sealing arrangement according to claim 49, wherein the sealing ring is arranged in a circumferential groove of the shaft, lifting rod or piston.

52. The sealing arrangement according to claim 51, further comprising an O-ring arranged in the groove of the shaft, lifting rod or piston on a low-pressure side of the sealing ring, the O-ring resting on a side surface of the sealing ring.

53. A sealing arrangement comprising a sealing ring according to claim 32, a shaft, lifting rod or piston, and a housing, wherein the first retaining projection of at least one of the circular segments has a radial thickness greater than a radial play between the sealing ring and the shaft, lifting rod, piston, or housing at a height of the first retaining projection.

54. The sealing arrangement according to claim 53, wherein the first retaining projection of the sealing ring is a part of the sealing surface of the sealing ring against the component to be sealed.

55. The sealing arrangement according to claim 49, wherein the sealing ring is pressurized under sealing contact on the shaft, lifting rod or piston or the housing with a pressure of ≧15 bars.

56. The sealing arrangement according to claim 49, wherein at least one of the circular segments is fixed in an interlocking fashion to the shaft, lifting rod or piston with respect to spacing in a radial direction.

57. The sealing arrangement according to claim 49, wherein all of the circular segments, when the sealing ring is mounted on the shaft, the lifting rod or piston, are fixed to each other in an interlocking fashion with respect to spacing from each other in a radial direction.
